(19) United States
(12) Patent Application Publication
(10) Pub. No.: US 2015/0352947 A1
(43) Pub. Date: Dec. 10, 2015

(54) DEVICE AND SYSTEM FOR AUTOMOTIVE REFUELING

(71) Applicant: PURPLE SERVICES, INC., Beverly Hills, CA (US)

(72) Inventors: Jean-Pierre Hubschman, Beverly Hills, CA (US); Bruno Uzzan, Beverly Hills, CA (US); Jason Wilson, Los Angeles, CA (US)

(21) Appl. No.: 14/731,320

(22) Filed: Jun. 4, 2015

Related U.S. Application Data
(60) Provisional application No. 62/007,883, filed on Jun. 4, 2014.

(51) Int. Cl. B60K 15/04; B60Q 9/00

(52) U.S. Cl. CPC B60K 15/0406; B60Q 9/00; B60K 2015/0321

(57) ABSTRACT

Embodiments of the present invention provide a new smart fuel cap and system for an improved refueling system of a vehicle. In particular, the smart fuel cap can be in communication with a user's smart phone for generating and sending a fuel order to a refuel service provider. According to some aspects, sensors of the smart fuel cap and/or the user's smart phone can be used for an input of a low fuel condition for the fuel order which can be specific to the vehicle's location. In some embodiments, the ability to determine and use the vehicle's location can be used to selectively allow access to an otherwise secure fuel cap for refueling.

### RELATED APPLICATIONS

This application claims priority to U.S. Provisional Patent App. No. 62/007,883, titled “SYSTEM FOR AUTOMOTIVE REFUELING”, filed on Jun. 4, 2014 being incorporated by reference as if set forth in full herein.

### FIELD OF THE INVENTION

The present invention relates generally to the field of automotive components, and more particularly to improved fuel delivery services using a smart networked device to determine a low fuel condition, communicate data to a fuel service provider and allow access to a secured fuel tank.

### BACKGROUND OF THE INVENTION

Fueling consumer vehicles is a time consuming and labor intensive practice for the vehicle user. The current practice is for the user to (1) monitor the vehicle fuel level; (2) determine a low fuel condition; (3) locate a fueling station; (4) purchase fuel; (5) gain access to the fuel tank; and (6) manually service the fuel tank.

Other previously user labor intensive services have been streamlined using smart phone technology. As an example, car service procurement typically requires the user to determine the need for a car, locate a car services' contact information, determine and communicate the desired pickup location, negotiate the type and amount of payment at the end of the service, and pay. This process has been streamlined to the point where the user simply launches a smart phone application and pushes a button to request the car service. The phone determines the location of pickup which is utilized by the service to locate a nearby and available driver in the area and direct the driver to the corresponding pickup location. At the end of the service the payment to the driver is automatically taken care of by the service provider based on previous payment information provided by the user.

This type of service streamlining is also desirable to enable fuel delivery services. One could consider a somewhat parallel path approach to the driver procurement streamlining above. Similarly, for example, a smart phone App could allow a user to request fuel service at the touch of a button. The smart phone App would determine the location of the phone and transmit a request for fuel delivery to a fueling service. The fueling service would arrive at the location of the phone to service the vehicle fuel needs. Payment could also be handled similarly to the taxi procurement applications. However, to enable this in a way that is useful, various additional requirements that are specific to fuel delivery must be accounted for. First, this conventional process would still require the user to monitor the fuel level, determine a low fuel condition, and manually request a fuel service based solely on when and where the user believes there is a need. In addition, in some vehicles the user would have to be present at the vehicle during refueling, provide vehicle keys to the service provider, or leave the vehicle unlocked in order to provide access to the fuel tank. Finally, there would not be a way to regulate or monitor that the desired amount and fuel type was actually provided by the refueling service.

As a result, there is a need for an innocuous device to can enable or perform at least some of the following: (1) determine and monitor a fuel level condition; (2) communicate a fuel need and vehicle data to a fuel provider; (3) allow the approved fuel provider access to an otherwise secure fuel tank for servicing; and (4) monitor refueling amount and fuel consumption performance.

### SUMMARY OF THE INVENTION

The foregoing needs are met, to a great extent, by the present invention, wherein in some aspects of embodiments of the invention are intended to address one or more of the above noted fundamental problems associated with the fueling of consumer vehicles. More specifically, disclosed is a new fuel cap device and/or new fuel electronic dongle capable of at least some of: (1) monitoring the vehicle fuel level; (2) enabling the transmission of data to a fuel service company; (3) allowing a fuel service technician access to an otherwise secured fuel tank; and (4) monitor refueling amount and fuel consumption.

According to some aspects of the disclosure, a portable fuel electronic dangle for a vehicle's refueling system is disclosed. In particular, the fuel electronic dangle comprising: a body including a processor accessible with a network access device via a communication network; and executable software stored on a memory and executable on demand, the software operative with the processor to enable transmission of fuel level related data with (1) at least one of (a) a fuel level sensor and (b) a global positioning system (GPS); and, (2) a user's smart phone App. According to some aspects of the disclosure, the fuel electronic dongle is configured as a smart fuel cap for a vehicle. In a smart fuel cap, the body can include a gas tank coupling structure on a distal end and a handling structure on a proximate end; an antenna in connection with the processor for enabling wireless communication between the processor and the user's smart phone; and an accelerometer in communication with the processor.

In some embodiments, the smart fuel cap also includes the global positioning system (GPS) and the processor is additionally operative with the software to activate the global positioning system according to a signal from received from the accelerometer. Moreover, signals from the accelerometer may also be correlated to acceleration of the vehicle in a fuel consumption calculation which may also be carried out by the system. According to yet additional aspects, the smart fuel cap can include a transducer and microphone (e.g., an ultrasonic sensor) positioned in the distal end of the body and in communication with the processor for a determination of a fuel amount contained in the vehicle's fuel tank. Other sensors that may be used for fuel consumption calculations and/or warning signals may include but are not limited to, for example, a gyroscope, vapor sensor(s), temperature sensor(s), pressure sensor(s), and the such. Information that may be used with sensor measurements can include fuel consumption for the vehicle's model and year, octane fuel ratings user preferences, inputs from the user relating to vehicle's occupancy, and the such.

According to additional aspects of the disclosure, a system for processing a fuel delivery order is disclosed. In particular, the system including: a server in communication with a wireless device, wherein the wireless device is configured via an app to transmit data to and from a smart fuel cap; a subscriber database including users' information including at least a user ID number and one or more corresponding vehicle(s)' model information; a fuel provider database including fuel provider's information including at least a provider ID number; and executable software stored on a memory and executable on demand, the software operative with a processor of the server to: receive the vehicle location and an order confirmation from the app, wherein the order confirmation is sent by the smart phone app in response to one or more of: a user order input and the remaining fuel volume determination being below a pre-determined threshold; select a subscriber ID number and a vehicle; and send a refuel order to a fuel provider included in the fuel provider database. In some embodiments, the smart fuel cap may include: a smart fuel processor, a global positioning system, and executable software stored on a memory and executable on demand to be operative with the smart fuel processor to transmit data corresponding to a remaining fuel volume and a vehicle location.

In yet additional aspects of the disclosure, the system for processing a fuel delivery order comprises: (a) a server in communication with a wireless communication device of a smart fuel cap, the wireless communication device is configured, via an app installed on a user's smart phone, to transmit data to and from the smart fuel cap and wherein the smart fuel cap includes a processor, one or more sensors, and executable software stored on a memory and executable on demand to be operative with the processor to transmit a signal when the remaining fuel volume is below a pre-determined amount; (b) a subscriber database including users' information including at least a user ID number and one or more corresponding vehicle(s)' model information; (c) a fuel provider database including fuel provider's information including at least a provider ID number; and (d) executable software stored on a memory and executable on demand, the software operative with a processor of the server to: (i) receive a vehicle location and an order confirmation from the app, wherein the order confirmation is sent by the smart phone app in response to one or both of: a user order input and a remaining fuel volume determination being below a pre-determined threshold; (ii) select a subscriber ID number and a vehicle; and (iii) send a refuel order to a fuel provider included in the fuel provider database.

According to some aspects, the executable software stored on a memory and executable on demand of the various embodiments is additionally operative with a processor of the server to receive an indication that a fuel provider has arrived at the vehicle's location and, in response to the received indication, send a signal that authorizes a locking system of the vehicle to unlock a smart fuel cap lock that can be used to prevent unwanted removal of the smart fuel cap from the vehicle's fuel tank.

There has thus been outlined, rather broadly, certain aspects of the invention in order that the detailed description thereof herein may be better understood, and in order that the present contribution to the art may be better appreciated. There are, of course, additional aspects of the invention that will be described below and which will also form the subject matter of the claims appended hereto.

In this respect, before explaining at least one aspects of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention.

FIG. 1 provides a flowchart illustrating exemplary interconnections between refuel system components according to some aspects of the disclosure;

FIG. 2 provides a schematic diagram showing exemplary smart fuel cap electronic components according to some aspects of the disclosure;

FIG. 3 provides the schematic diagram of FIG. 2 showing active components during idle;

FIG. 4 provides the schematic diagram of FIG. 2 showing active components during tracking mode;

FIG. 5 provides the schematic diagram of FIG. 2 showing active components during refuel mode;

FIG. 6 provides a flow diagram of an exemplary embodiment of the smart fuel capes computer logic according to aspects of the disclosure;

FIG. 7 provides a schematic of different exemplary communication configurations of the smart fuel cap;

FIG. 8 provides a schematic of different exemplary communication configurations of a vehicle mounted electronic dangle; and

FIG. 9 provides exemplary method steps for a smart refueling system in a flow diagram according to aspects of the disclosure.

The present invention is further described in the detailed description that follows.

### DETAILED DESCRIPTION OF THE INVENTION

The present disclosure provides for a system in which one or more of these problems can be addressed by the installation of a fuel electronic dangle which, in some embodiments, may be configured as a smart fuel cap. By smart it is meant that the electronic dongle/smart fuel cap is an electronic device, generally connected to other devices or networks via different protocols such as Bluetooth, NFC, WiFi, 3G, RFID, etc., that can operate to some extent interactively and autonomously. In accordance with the disclosure, the use of the described electronic dangle/smart fuel cap embodiments and related aspects can enable facilitated and streamlined automated fueling service to a consumer. More specifically, a device for a fuel delivery system is described being capable of communicating with the user's smart phone and performing at least some of: (1) monitoring the vehicle fuel level; (2) transmitting data to a fuel service company; (3) and allowing a fuel service technician access to an otherwise secured fuel tank. Communication with the user's smart phone can allow the device to use the existing wireless data infrastructure already in place to communicate the fuel need and vehicle data to the fuel service provider. Furthermore the phone can act as rich user interface to communicate with the service provider and the device.

According to some aspects, data transmitted to the fuel service company includes a request with pertinent information relating to the fuel service including vehicle location, fuel type, estimated fuel required, user account information, window of fueling opportunity and the like. In some embodiments, the device may use the vehicles on board sensors through typical sensor interfaces (e.g. OBD II) or be self-contained including all required electronics.

A self-contained embodiment can be in the form of the smart fuel cap, for example. The smart fuel cap can have the capability to measure or infer the vehicle fuel level to determine a low fuel level via one or more sensors including, for example, an ultrasonic sensor. The cap may also have geo-location sensors (e.g. GPS) used to determine the location of the vehicle to facilitate vehicle localization by the refueling technician and/or for a fuel consumption calculation. Any type of memory including, for example, a magnetic disk drive, a solid state disk drive, a floppy disk drive, a tape drive, a Zip drive, a flash memory card, and/or a memory stick can be used to store vehicle information to further facilitate vehicle identification by the refueling technician. In addition, user information may also be stored and correlated to an account and payment information in the memory to facilitate automatic payment.

According to yet additional aspects, the fuel cap may also be configured to lock and secure itself to the fuel tank and/or communicate with a vehicle's locking system to lock/unlock provide an alarm to the user. The refueling technician may gain access to the smart fuel cap and/or cover using an electronic smart key or by an indication that the refueling technician has arrived at the vehicle's destination at a scheduled time for refueling. Finally the smart fuel cap may be configured for access to a cellular network to communicate data to the fueling service.

Various aspects of the electronic device may be further illustrated with reference to one or more exemplary embodiments. As used herein, the term “exemplary” means “serving as an example, instance, or illustration,” and should not necessarily be construed as preferred or advantageous over other embodiments of a steering arm disclosed herein.

Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

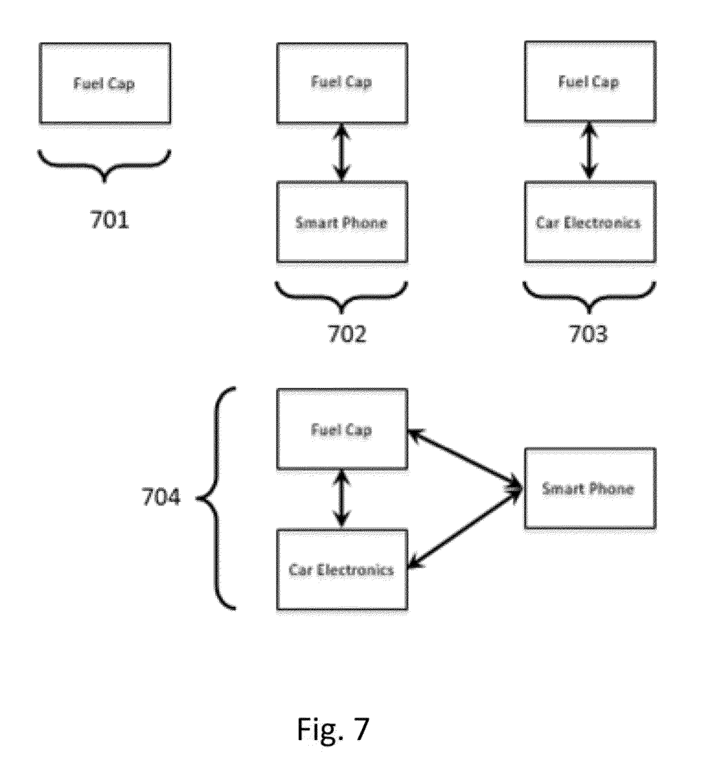

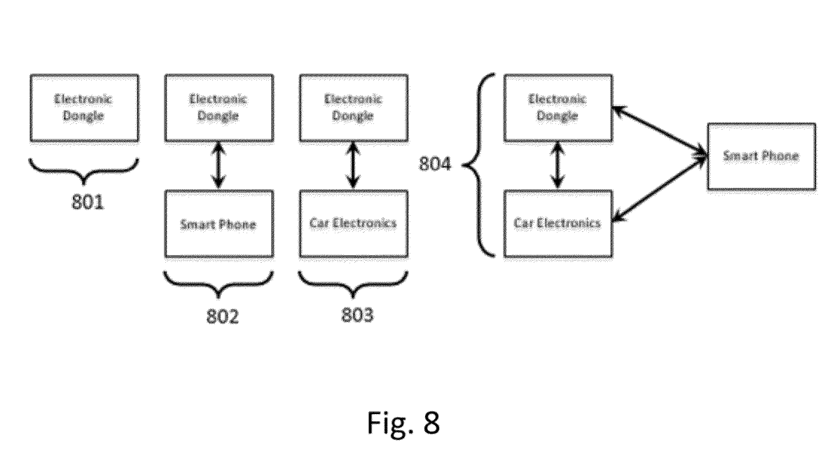

Beginning now with FIGS. 7 and 8, schematics of different exemplary communication configurations of a smart fuel cap and electronic fuel dongle are illustrated. In particular, the diagrams illustrate exemplary potential communication modalities of the smart fuel cap/electronic fuel dongle which differ at least in part due to the different components that may contained by the respective device. Referring to FIG. 7, a smart fuel cap 701 is shown in which all resources used to facilitate low fuel detection, fuel service requests using electronic data networks, geographical localization, securing the fuel tank, user interface requirements, data transfer between devices and the like can be self-contained in the device. Self-contained resources may include, for example, a global positioning system (GPS), an accelerometer, wireless communication device, a processor, memory, an electronic lock, power source, and one or more sensors (e.g., gyroscope, a transducer and microphone sensor ((e.g., ultrasonic sensor)), pressure sensor, vapor sensor, temperature sensor). The various resources can function according to aspects of the disclosure, including as expressly described in other parts of this description.

With respect to the self-contained smart fuel cap embodiment at 701, a reduction in complexity, cost, and power requirements may be desired. As a result, communication protocols for smart fuel caps that may be in communication with a smart phone 702, a vehicle's on board computer 703, or both the smart phone and the vehicle's on board computer 704 are also contemplated and illustrated. Generally, by each of the different communication protocols, the smart fuel cap may obtain the benefit of the smart phone and/or vehicle's onboard computer's resources to facilitate refueling according to this disclosure. As previously mentioned, the devices may generally be connected to other devices or networks via wired and/or different protocols such as Bluetooth, NFC, WiFi, 3G, RFID, etc., that can operate to some extent interactively and autonomously.

At 702, the smart fuel cap is shown in communication with a smart phone. By providing this communication with a smart phone, resources available to the phone including a user interface, GPS, data network, processor power, memory, storage and the like may be used by the smart fuel cap.

At 703, the smart fuel cap is shown in communication with the vehicle's on board computer. In this case, any resources available to the vehicle may be available to the fuel cap including fuel level sensors, vehicle speed, vehicle mileage, vehicle GPS, engine sensor data, transmission sensor data, dashboard user interface and the like.

At 704, the smart fuel cap is shown in communication with both the car electronics and the user smart phone. With this configuration, both sets of resources available in 702 and 703 can be available to the smart fuel cap.

Referring now to FIG. 8, fuel electronic dongle and the same communication modalities of FIG. 7 are shown. While the same communication modalities are shown, because the fuel electronic dongle may be connected directly to a vehicle/smart phone interface, wireless communication may not be required between devices. In particular, since the electronics previously housed in a fuel cap are now part of a stand-alone portable electronic device. Beginning at 801, the fuel electronic dongle may similarly be self-contained and include all of the resources of the 701 self-contained smart fuel cap. One advantage that may be provided by the fuel electronic dongle 801 over the gas cap 701 is the ease of re-charging/connecting a power source to the fuel electronic dongle.

In another configuration shown at 802, the smart fuel dongle may be in communication with the user's smart phone and thus may share resources between the two devices. One non-limiting example being fuel level estimation and vehicle localization facilitated by the electronic dongle and cellular data communication and user interface facilitated by the user smart phone. At 803, the electronic fuel dongle may be in communication with the vehicle's on-board computer. This communication may be a wireless communication modality (e.g. Bluetooth) or a physical interface. In the case of the physical interface, the dangle may be hard wired into the vehicle electronics requiring some integrated installation or alternatively it may be plugged into the vehicles OBD II port available on most automobiles since 1996. In this configuration the electronic fuel dangle and vehicle's on-board computer can share resources with each other. One example includes the electronic fuel dangle facilitating cellular data communication and computer processing while the vehicle makes on board sensors available for fuel level estimation and vehicle localization.

Finally, at 804, the electronic fuel dangle may be in communication with both the smart phone and the vehicle's on-board computer. In this case, resources may be shared in many combinations as previously described individually and as will be apparent to one skilled in the art.

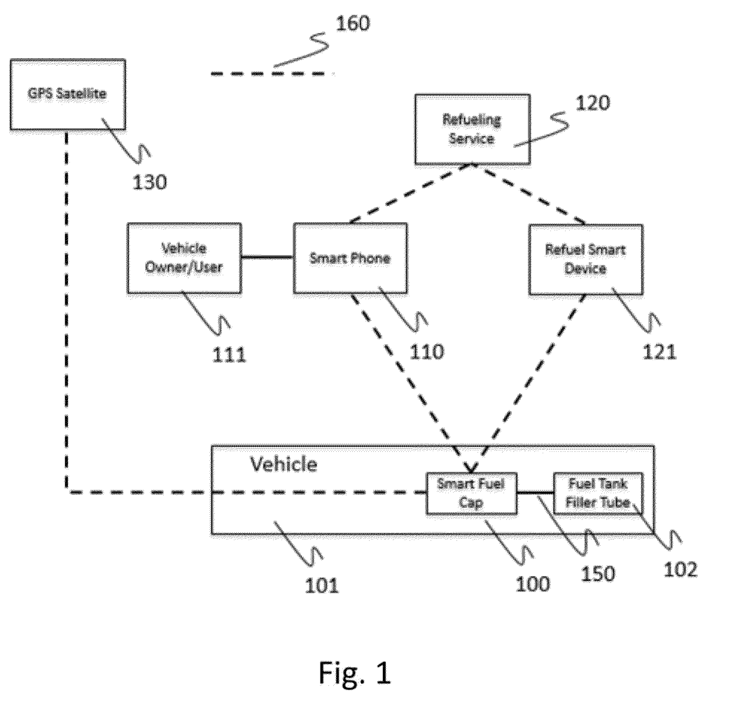

Referring now to FIG. 1, a flowchart illustrating exemplary interconnections between system components—including a smart fuel cap 100—is shown. Here the fuel cap may be attached to the fuel tank filler tube 102 via a mechanical interconnection 150. The interconnection can be such that it may provide a seal to the fuel container and be configured in a locked or unlocked state. The fuel cap 100 can be a smart automotive part that replaces a component of the vehicle 101, namely the OEM fuel cap. The individual components of the system can communicate wirelessly as denoted by the dashed lines 160. Moreover, in some embodiments, the fuel cap can detect signals from GPS satellites. The signals from GPS satellites can be used to measure a time series of geographic information. This information can include time, longitude, latitude, elevation and the like. In accordance with aspects of the disclosure, this information can be implemented for (1) fuel level estimation, (2) vehicle localization, and (3) trip recording.

Communication between the various components may occur, for example, once a low fuel state is detected. Upon low fuel detection, the cap can initiate a request for fuel to the refueling service 120. As previously described, in one embodiment, the smart fuel cap may use the vehicle owner/user's 111 smart phone 110 to request fuel service. The transmission of the request can be via wireless communication (e.g. Bluetooth) from the smart fuel cap to the wireless device in which an app can forward the request to the service provider using the cellular providers' data network. In another embodiment the fuel cap can have on board cellular circuitry to make a request directly from the device.

Once the refueling service is requested, a refueling technician 122 can be notified by the refuel smart device 121 that the associated vehicle is in need of service as well as other pertinent data to facilitate the service. Examples of this pertinent data include vehicle location, vehicle description, fuel type, and optional requested services. Upon locating the vehicle, according to aspects of some embodiments, the refueling technician 122 can use the refuel smart device 121 to unlock the smart fuel cap 100 to access the fuel tank filler tube 102 to refuel the vehicle 101. Furthermore, information about the refueling procedure can be transmitted to the smart fuel cap 100. This information can be used to notify the vehicle owner/user 111 about the refueling event, for vehicle fuel consumption performance monitoring, for the locking of the fuel tank and the such. For example, the amount of fuel delivered to the vehicle can be used by the smart fuel cap 100 to accurately track the fuel level until the next fueling event.

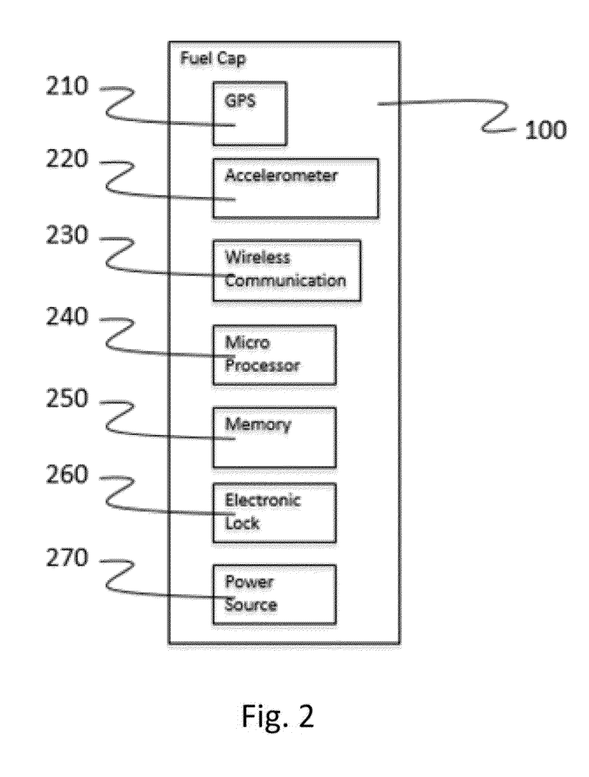

Referring now to FIG. 2, a schematic of the smart fuel cap resources/electronic components is shown. According to some aspects, sensors can include accelerometer 220 and GPS 210 electronics to determine when the vehicle is in motion and the trip information. Wireless communication 230 electronics can also be included to facilitate syncing with the smart user device and/or vehicle's on-board computer to allow access to the fuel tank via the electric lock 210. A microprocessor 240 is available to perform numerical computing tasks including data acquisition, fuel consumption calculations, data recording, and smart user device communication. Memory 250 is available to store, among other things, GPS 210 and accelerometer 220 data, electronic lock 260 access information, fuel level, refueling status, fueling information, software executable code for performing the fuel consumption calculations and controlling the transmission of data between devices and the like. Finally a power source 270 is needed to run the electronics. The power source may include for example, a battery which may be replaced or recharged as needed.

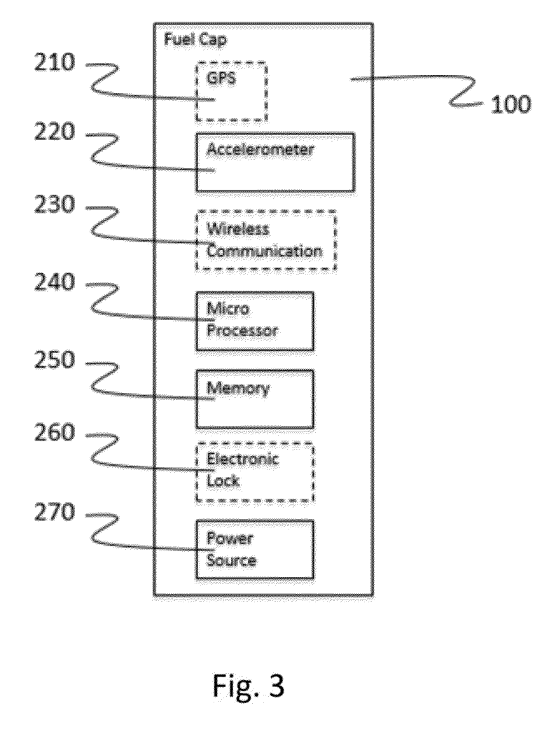

Referring now to FIG. 3, the schematic diagram of FIG. 2 is shown indicating those active components during an idle mode. Particularly, the solid lines denote active components while dashed lines denote electronics that can be shut off, on standby, or in a power save mode during idle mode. Idle mode may be initiated by the microprocessor 240 when it stops receiving indications of movement from the accelerometer 220 in a pre-determined period of time. For example, the microprocessor 240 can reads measurement signals from the accelerometer 220 and temporarily stores them data in memory. It can then analyze the accelerometer data over a recent history window (e.g., 3-5 minutes) to determine if the vehicle is stationary or in use. Upon a determination by the microprocessor 240 that the vehicle is stationary, the system may innocuously go into idle mode. By having this idle mode, battery power conserved.

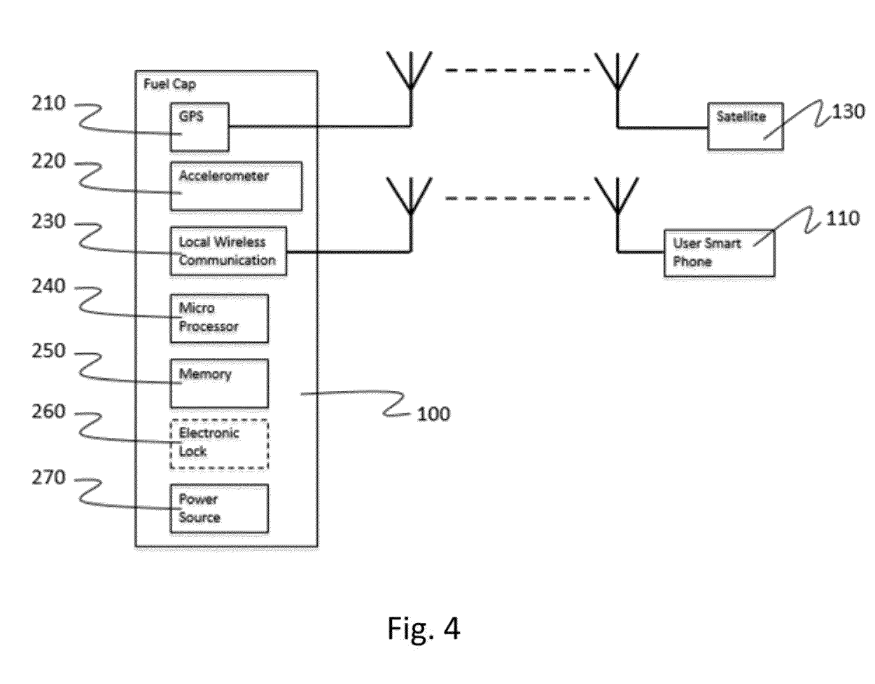

Referring now to FIG. 4, the schematic of FIG. 2 is shown indicating those active components during tracking mode. Similarly, in FIG. 4 the solid lines denote active components while dashed lines denote electronics that can be shut off, on standby, or in a power save mode. As depicted, during tracking mode everything can be powered except for the electronic lock. The active components during tracking enable the smart fuel cap's 100 monitoring the GPS satellite 130 signals and logging the vehicle 100 time series of geographical information. In addition, based off this information the fuel level can also be estimated during the tracking and without significant delay. According to some aspects, during tracking the smart fuel cap can be paired with the user smart phone 110 using (e.g. Bluetooth) wireless communication electronics 230 to leverage the phone's onboard resources. As a non-limiting example, the wireless communication between the smart fuel cap and the smart phone 110 can be initiated when a low fuel condition is signaled by the smart fuel cap 100 to contact the refueling service 120 provider. According to some aspects, because this is the most power consuming mode due to the GPS and Bluetooth communication, the time spent in this mode where all but the lock are active should be restricted to drive time to optimize overall power consumption.

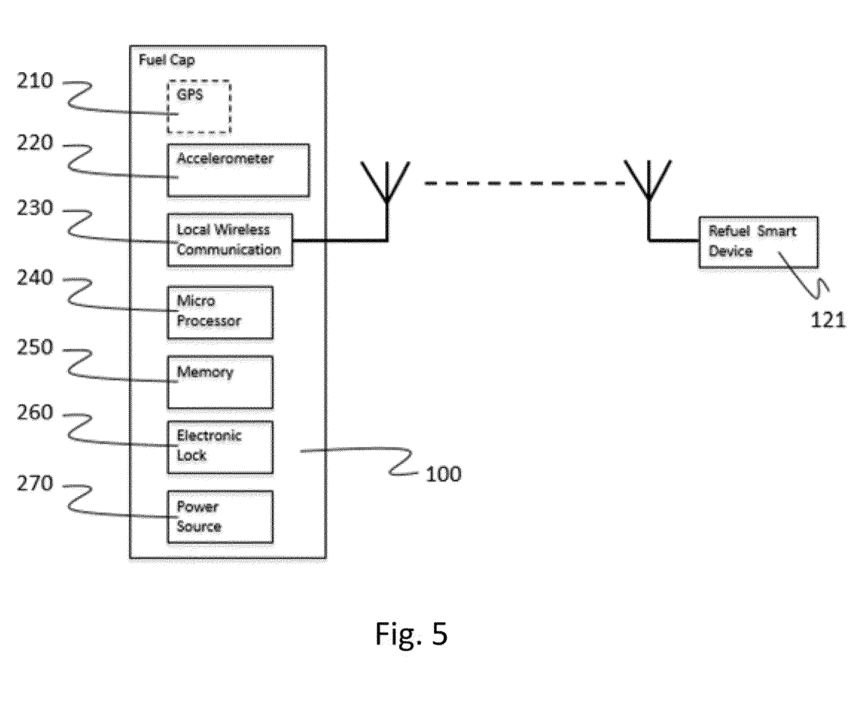

Referring now to FIG. 5, the schematic of FIG. 2 is shown indicating those active components during refuel mode. Because in this mode, the vehicle has become stationary, when the refueling request including a refueling location is sent to the refueling system, the settings of the idle mode are overwritten for a period of time thereafter, when the fuel provider's technitial arrives at the destination, or according to a confirmation schedule indicating when refueling is to take place. According to some aspects, in refueling mode the local wireless communication stays active so that it may communicate with a refuel provider technician's system interface. For example, upon arrival of the refuel service technician to location area proximate to the vehicle, the fact that these components are active can help enable a local wireless communication to act as a local low power beacon to further help the refueling technician to locate the vehicle in cases where the GPS coordinates are not accurate (e.g. a parking garage). Further, once the smart fuel cap has wirelessly paired with the refuel smart device, the technician can unlock the cap wirelessly to allow for refueling. After refueling the refuel smart device transmits the refuel data to the smart fuel cap (e.g. gallons of fuel delivered) and the smart fuel cap can also be locked.

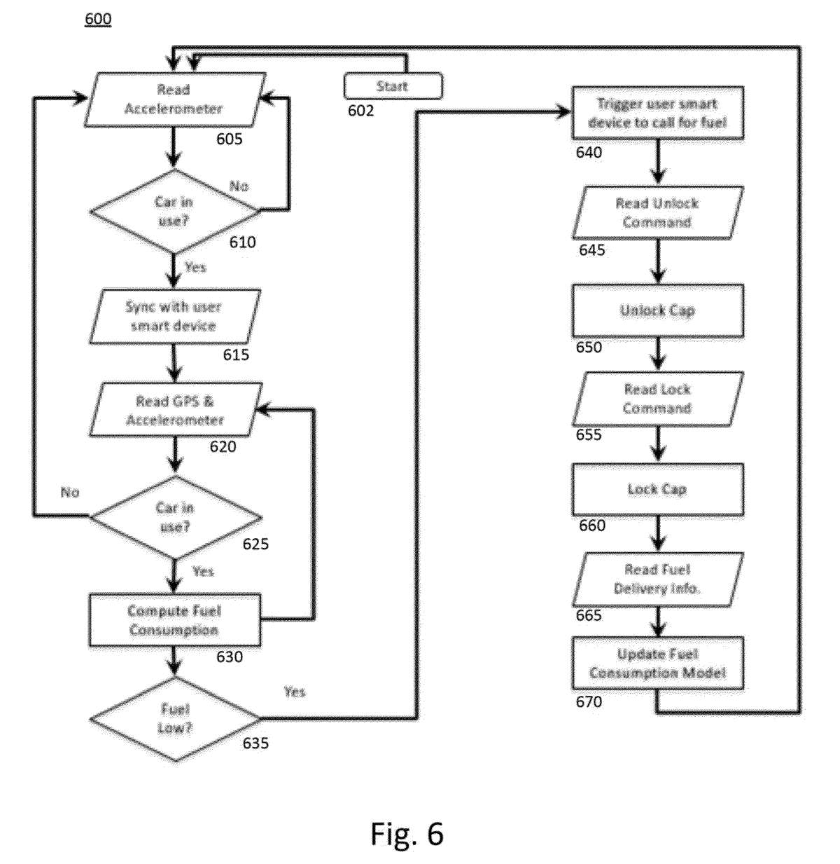

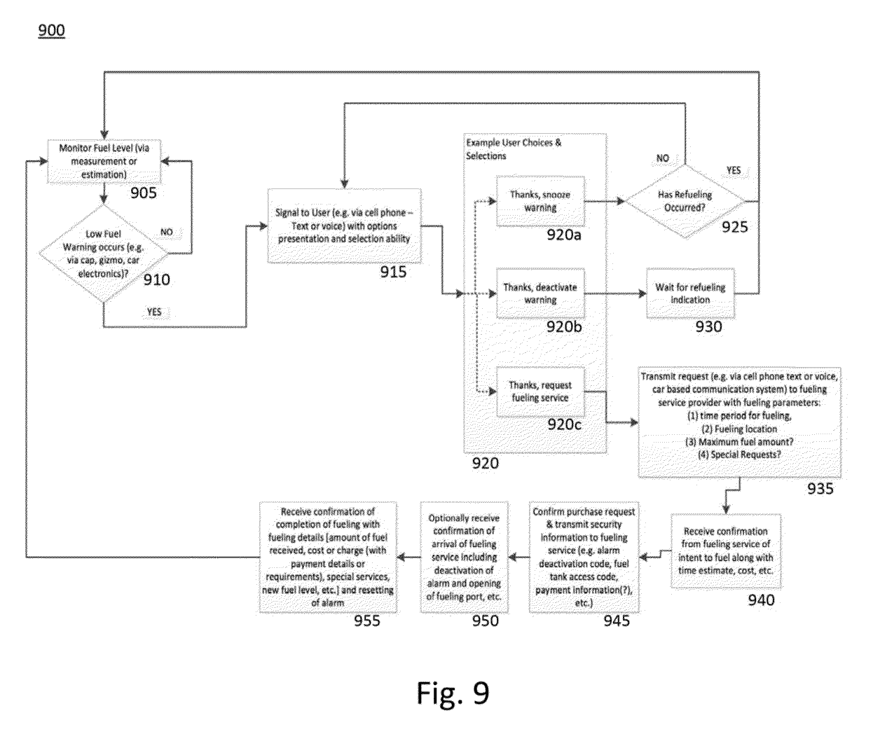

With respect to FIGS. 6 and 9, example methods that may be better appreciated with reference to flow diagrams are shown. While for purposes of simplicity of explanation, the illustrated methods are shown and described as a series of blocks, it is to be appreciated that the methods are not limited by the order of the blocks, as in different embodiments some blocks may occur in different orders and/or concurrently with other blocks from that shown and described. Moreover, less than all the illustrated blocks may be required to implement an example method. In some examples, blocks may be combined, separated into multiple components, may employ additional, not illustrated blocks, and so on. In some examples, blocks may be implemented in logic. In other examples, processing blocks may represent functions and/or actions performed by functionally equivalent circuits (e.g., an analog circuit, a digital signal processor circuit, an application specific integrated circuit (ASIC)), or other logic device. Blocks may represent executable instructions that cause a computer, processor, and/or logic device to respond, to perform an action(s), to change states, and/or to make decisions. While the figures illustrate various actions occurring in serial, it is to be appreciated that in some examples various actions could occur concurrently, substantially in parallel, and/or at substantially different paints in time.

Referring now to FIG. 6, a flow diagram 600 of an exemplary embodiment of the smart fuel cap computer logic is shown. Beginning at 602, the smart fuel cap and/or electronic fuel dangle is implemented in the refueling system. At 605, data from an accelerometer is read by the microprocessor. As previously explained, when it is detected that the vehicle is not in use the smart fuel cap may enter an idle mode. Once the accelerometer begins sending measurements corresponding to vehicle motion, a determination that the vehicle is in use can be made at 610.

Upon determining that the vehicle is in use, a tracking mode is entered and at 615 the fuel cap can attempt to sync with the user smart device to update information (e.g. recent fueling data). Furthermore, at 620 the GPS sensor is powered on and GPS/accelerometer information may be used to verify that the vehicle is in motion, at 625, and if it is then compute the fuel consumption 630. The fuel consumption calculation could simply be proportional to the mileage driven, based on the one or more sensors which may be included in some embodiments, or based on a sophisticated model using time series GPS data including time stamp, latitude, longitude and elevation. Furthermore, this model could be generated a priori based on experiments with similar vehicles, and/or dynamically updated based on previously recorded GPS/accelerometer data and fuel consumption.

At 635 a determination is made as to whether the fuel level is below a certain threshold. When it is determined that the fuel level is below the certain threshold, at 640, the user's smart device is triggered by the smart fuel cap to request a fuel service. The data sent to the smart device and subsequently to the fuel service can include the vehicle location, digital fuel lock access information and estimated required fuel.

According to some aspects, when the fuel service has been requested the smart fuel cap may enter a refuel mode. At 645, the cap can read the unlock command from the fuel service technician and actuate the unlock mechanism allowing the technician to remove the smart fuel cap and/or unlock a vehicle's fuel lid covering the fuel cap. Once fueling is over, at 660, the smart fuel cap reads the lock command and locks the cap and/or fuel cap cover. In some embodiments, at 665 the smart fuel cap can read the fueling information from the fuel service. This information can include amount of fuel delivered, price, and type of fuel, all which may be delivered directly to the user's smart phone fueling app. in the case of a self-contained system. Additionally, in the case of a self-contained system the fuel service technician may also replace the battery if it is low.

Alternatively, when the smart fuel cap is not self-contained, the smart fuel cap may be recorded in the memory and transmitted the next time the user's smart phone and smart fuel cap are paired. In some embodiments, the service provider may send all of this information directly to the refueling app. At 670, the information received may be used to update a fuel consumption model that can be used by the system.

Referring now to FIG. 9, exemplary method steps for a smart refueling system in a flow diagram 900 according to aspects of the disclosure are shown. At 905, the smart fuel device monitors the fuel level. When a low fuel condition is determined at 910, the user is signaled through a personal smart device (e.g. smart phone) 915. As an example, the user may make a selection 920 of options provided. For example, three courses of action can include snooze 920A, deactivate 920B, or request service 920C. Snooze allows the user a window of time to fuel the vehicle. Periodically the system checks for a refueling event. When it is determined after a period of time that refueling hasn't occurred 925, the user is alerted again that fueling is needed. If the user chooses deactivate, the system simply waits for a fueling event 930. Once fueling occurs the system must be told that the fueling event occurred in order to go back to the fuel monitoring mode. In the case that fuel service is requested by the user, a number of events may occur.

At 935, the request is first transmitted. This request may include time period for fueling, fueling location, maximum fuel amount, special requests and the like. The user then may receive a confirmation at 945 from the fueling company expressing their intent to refuel as well as time estimate until refueling, cost, acceptance of special requests and the like. After the confirmation at 945 is received, at 950, the user may then have an opportunity to confirm the fueling terms and then, for example when an arrival confirmation is received or according to a scheduled time, the user may send fueling information such as alarm deactivation information, tank access codes, payment information, and the like as part of the purchase request. After fueling, at 955, the fuel service provider may send a message notifying the user that the fueling event has occurred including final payment information, receipt, details of included services, duration of fueling event, and any notes. The smart fueling device is then reset back to monitor fuel levels.

In accordance with general aspects previously described, the smart fuel cap can be self-contained with sensors and a battery requiring no external power source or connectivity with the vehicle. This would allow installation of the smart fuel cap to be as easy as replacing a standard fuel cap. The cap communicates with the user smart phone by way of a standard mobile OS application leveraging the cellular data network and rich user interface. The refueling service can also be used to service the battery pack to eliminate the user from needing to charge device.

In this embodiment the smart fuel cap may need to estimate the vehicle fuel level to determine a low fuel condition. The GPS sensor can be used to track the time series of vehicle use. Metrics that can be measured or inferred from this information are position, speed, acceleration, elevation and the like. From this data the fuel level can be estimated. The simplest model is to linearly map the mileage driven to gallons of fuel burned. At some threshold mileage a low fuel condition is determined. More complicated models can be used to map vehicle trip history to fuel consumption. Other more complicated, and presumably more accurate, fuel consumption estimation algorithms have been studied and can be employed by the smart fuel cap. These algorithms include Estimating Vehicle Fuel Consumption and Emissions based on Instantaneous Speed and Acceleration Levels, Kyoungho Ahn, Hesham Rakha, Antonio Trani, Michel Van Aerde, Journal of Transportation Engineering-asce—J TRANSP ENG-ASCE 01/2002; 128(2). DOI:10.1061/(ASCE)0733-947X(2002)128:2(182) and Fuel Consumption Modeling of Conventional and Advanced Technology Vehicles in the Physical Emission Rate Estimator (PERE): Draft, United States, Environmental Protection Agency. Office of Transportation and Air Quality. Assessment and Standards Division, Bob Gianelli, Ed Nam,

U.S. Environmental Protection Agency, 2005.

In another embodiment, the smart fuel cap may house its own cellular electronics and user interface. In this embodiment the pairing of the smart fuel cap with a smart phone is avoided.

In yet another embodiment, on board vehicle utilities may be exposed to the smart device. For example the fuel level sending unit information may be available through a physical connection with the device or wirelessly from the vehicle electronics. In this case fuel estimation based on vehicle information and embedded sensor time series may be avoided. Other utilities may include, power, fuel door actuation, vehicle data (vs user cellular data), and the like.

It may become necessary at any time for the user to manually fill the vehicle fuel. In a preferred embodiment the user's smart phone may be used to unlock the fuel cap to gain access to the fuel filler tube. Once fueling is completed, the fuel fill details may be entered into the phone and synced with the fuel cap to facilitate the next fuel tracking phase. If the smart fuel cap is in an idle mode, there may be a physical button on the cap to switch it to fuel filling mode.

Electronic keys that allow the refueling technician to open the fuel tank can be limited for extra security purposes. For example, the key may only be active for a certain time window after the fueling services are requested. Furthermore, the key may be limited to a certain geographic location.

The smart fuel cap may have an added feature of a theft deterrent device. If the vehicle is stolen, the thief will not have access to the fuel tank to refuel without the proper electronic key, effectively limiting the range of the vehicle after it is stolen. Furthermore, the fuel cap can also determine a “vehicle stolen” case autonomously. If the vehicle is driven without the user smart phone paired to the smart fuel cap, the smart fuel cap my be triggered to a suspicious activity mode. Then the smart fuel cap search for other smart fuel caps on the road using the local wireless communication electronics. When the smart fuel caps pair, the location of the vehicle may be sent to the refueling service with a suspicious use warning. This can then alert the user to confirm if the vehicle is stolen and alert authorities about the theft.

The many features and advantages of the invention are apparent from the detailed specification, and thus, it is intended by the appended claims to cover all such features and advantages of the invention which fall within the true spirit and scope of the invention. Further, because numerous modifications and variations will readily occur to those skilled in the art, it is not desired to limit the invention to the exact construction and operation illustrated and described, and accordingly, all suitable modifications and equivalents may be resorted to, falling within the scope of the invention.

We claim:

1. A portable fuel electronic dangle for a vehicle's refueling system, the fuel electronic dangle comprising:
a body including a processor accessible with a network access device via a communication network; and
executable software stored on a memory and executable on demand, the software operative with the processor to enable transmission of fuel level related data with (1) at least one of (a) a fuel level sensor and (b) a global positioning system (GPS); and, (2) a user's smart phone App.

2. The fuel electronic dangle of claim 1, wherein the electronic dangle is configured as a smart fuel cap having:
the body including a gas tank coupling structure on a distal end and a handling structure on a proximate end;
an antenna in connection with the processor for enabling wireless communication between the processor and the user's smart phone; and
an accelerometer in communication with the processor.

3. The smart fuel cap of claim 2, wherein the global positioning system (GPS) is included in the body and the processor is additionally operative with the software to activate the global positioning system according to a signal from received from the accelerometer.

4. The smart fuel cap of claim 2, wherein the processor is additionally operative with the software to receive vehicle traveled path GPS measurements for a fuel consumption calculation.

5. The smart fuel cap of claim 2, wherein the fuel level sensor includes a sonar transducer and a microphone positioned on/in the distal end of the body and in communication with the processor, and the processor is additionally operative with the software to receive and process signals from the sonar transducer and the microphone sensor for a determination of a fuel amount contained in the vehicle's fuel tank.

6. The smart fuel cap of claim 2, wherein the memory additionally includes pre-determined fuel consumption data corresponding to the user's vehicle, and wherein the processor is additionally operative with the software to determine a remaining fuel level using at least two or more of the pre-determined fuel consumption data corresponding to the user's vehicle, distance data from the global positioning system, and a at least one fuel level measurements from the fuel sensor.

7. The smart fuel cap of claim 2, additionally comprising:
a vapor sensor in communication with the processor, wherein the processor is additionally operative with the software to receive a vapor measurement and compare the vapor measurement to acceptable vapor predetermined values and send a warning signal when the vapor measurement falls outside the acceptable vapor predetermined values.

8. The smart fuel cap of claim 2, additionally comprising:
one or more pressure sensors in communication with the processor, wherein the processor is additionally operative with the software to receive pressure measurement data from the one or more pressure sensors for a fuel consumption determination.

9. The smart fuel cap of claim 8, additionally comprising:
a temperature sensor in communication with the processor, wherein the processor is additionally operative with the software to receive a temperature measurement from the temperature sensor, the temperature measurement to be used along with the pressure measurement data in the fuel consumption determination.

10. The fuel electronic dangle of claim 1, wherein the software is additionally operative with the processor to communicate with a locking system of the smart fuel cap and, in response to a signal received from the smart phone app or fuel provider, unlock the fuel cap and provide access to the vehicle's fuel tank.

11. A system for processing a fuel delivery order, the system comprising:
(a) a server in communication with a wireless device, wherein the wireless device is configured via an app to transmit data to and from a smart fuel cap, the smart fuel cap having:
a smart fuel processor, a global positioning system, and executable software stored on a memory and executable on demand to be operative with the smart fuel processor to transmit data corresponding to a remaining fuel volume and a vehicle location;
(b) a subscriber database including users' information including at least a user ID number and one or more corresponding vehicle(s)' model information;
(c) a fuel provider database including fuel provider's information including at least a provider ID number; and
(d) executable software stored on a memory and executable on demand, the software operative with a processor of the server to:
receive the vehicle location and an order confirmation from the app, wherein the order confirmation is sent by the smart phone app in response to one or more of: a user order input and the remaining fuel volume determination being below a pre-determined threshold;
select a subscriber ID number and a vehicle; and
send a refuel order to a fuel provider included in the fuel provider database.

12. The system of claim 11, wherein the executable software stored on a memory and executable on demand is additionally operative with a processor of the server to:
receive an indication that a fuel provider has arrived at the vehicle's location and, in response to the received indication, send a signal that authorizes a locking system of the smart fuel cap to unlock providing access to the vehicle's fuel tank.

13. The system of claim 11, wherein the executable software stored on a memory and executable on demand is additionally operative with a processor of the server to:
receive the order confirmation from the app,
search a schedule of the fuel provider; and
transmit a proposed time and location for refueling to the app.

14. The system of claim 11, wherein the executable software stored on a memory and executable on demand is additionally operative with a processor of the server to:
send fuel price updates to a user via the app., wherein the fuel prices correspond to an area proximate to a location measured by the global positioning system of the smart fuel cap.

15. The system of claim 11, wherein the remaining fuel determination is made using data from one or more sensors of the smart fuel cap.

16. A system for processing a fuel delivery order, the system comprising:
(a) a server in communication with a wireless communication device of a smart fuel cap, the wireless communication device is configured, via an app installed on a user's smart phone, to transmit data to and from the smart fuel cap and wherein the smart fuel cap includes a processor, one or more sensors, and executable software stored on a memory and executable on demand to be operative with the processor to transmit a signal when the remaining fuel volume is below a pre-determined amount;
(b) a subscriber database including users' information including at least a user ID number and one or more corresponding vehicle(s)' model information;
(c) a fuel provider database including fuel provider's information including at least a provider ID number; and
(d) executable software stored on a memory and executable on demand, the software operative with a processor of the server to:
(i) receive a vehicle location and an order confirmation from the app, wherein the order confirmation is sent by the smart phone app in response to one or both of: a user order input and a remaining fuel volume determination being below a pre-determined threshold;
(ii) select a subscriber ID number and a vehicle; and
(iii) send a refuel order to a fuel provider included in the fuel provider database.

17. The system of claim 16, wherein the executable software stored on a memory and executable on demand is additionally operative with a processor of the server to:
receive an indication that a fuel provider has arrived at the vehicle's location and, in response to the received indication, send a signal that authorizes a locking system of the smart fuel cap to unlock providing access to the vehicle's fuel tank.

18. The system of claim 16, wherein the vehicle's location is provided to the fuel provider with a low power beacon function provided by the smart fuel cap.

19. The system of claim 17, wherein the vehicle's location corresponds to data received from a global positioning system of the user's smart phone.

20. The system of claim 17, wherein the vehicle's location corresponds to data received from a global positioning system of the smart fuel cap.
